(19) United States
(12) Patent Application Publication
(10) Pub. No.: US 2005/0228556 A1
(43) Pub. Date: Oct. 13, 2005

(54) Vehicle display apparatus

(75) Inventor: Mitsunari Kojima, Anjo-shi (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha

(21) Appl. No.: 11/100,523

(22) Filed: Apr. 7, 2005

(30) Foreign Application Priority Data
Apr. 8, 2004 (JP) 2004-114484

(51) Int. Cl. G06F 7/00

(52) U.S. Cl. 701/29; 701/1

(57) ABSTRACT

A vehicle display apparatus comprises a vehicle states detecting means (11) for detecting states of a vehicle, a display means (12) for displaying vehicle information according to the states of the vehicle detected by the vehicle states detecting means, and a mode-of-display changing means (13) capable of changing the mode of displaying the vehicle information on the display means. The mode-of-display changing means receives specifications information about the vehicle and changes the mode of display on the display means according to the specifications information.

### CROSS-REFERENCE TO A RELATED APPLICATION

This application incorporates by reference the subject matter of Application No. 2004-114484, filed in Japan on Apr. 8, 2004, on which a priority claim is based under 35 U.S.C. §119(a).

### BACKGROUND OF THE INVENTION

1. Field of the Invention

This invention relates to a vehicle display apparatus installed in a vehicle to show various states of the vehicle, and particularly to a vehicle display apparatus in which a main control unit receives the specifications of the vehicle and changes the mode of displaying information.

2. Description of the Related Art

Vehicles are provided with a display apparatus which includes a speedmeter for indicating vehicle speed, a tachometer for indicating engine speed, a fuel gauge for indicating the amount of fuel remaining in a fuel tank, a door warning light for warning that a door is open, other indicator lights for indicating various measured values and warnings, etc.

The display apparatus of this type varies in display items, notation (language specification), measured-value response characteristics, etc., depending on differences in vehicle specifications. Thus, vehicle display apparatuses are prepared according to the vehicle specifications. Incidentally, even vehicles of the same model can be different in specifications. For example, vehicles of the same model can differ in the vehicle shape (For example, the characteristics of the fuel gauge, a mark indicating the vehicle shape, etc. depend on the vehicle shape.), the position of a driver's sheet (left-hand drive or right-hand drive), the specifications of an engine (The tachometer, engine-related warning lights and operation lights, the fuel gauge, the speedmeter, etc. depend on the engine specifications.), the specifications of a transmission (AT-related operation lights and warning lights depend on the transmission specifications), the specifications of ECU's (ECU-related operation lights and warning lights depend on the ECU's specifications), the specifications of lighting (a light control system, a DRL), etc. Further, vehicles of the same model can differ in specifications, depending on the model year (due to partial changes to the vehicle specifications, revisions to regulations concerning display, etc.) and the destination to which the vehicle is intended (for example, which of the units km/h and MPH should be used in an odometer/trip meter, and what language should be used for warnings depend on the destination). Thus, different vehicle display apparatuses need to be prepared according to differences in the vehicle specifications.

In order to solve this problem with the conventional vehicle display apparatus, namely the problem that different display apparatuses need to be prepared according to differences in the vehicle specifications, there has been proposed a vehicle display apparatus which includes parts usable for all vehicle models in common to reduce effort required in designing vehicles (see Japanese Unexamined Patent Publication No. hei 5-272991).

In the case of the conventional vehicle display apparatus described above, even for vehicles of the same model, different display apparatuses need to be prepared according to differences in the vehicle specifications. Considering the vehicle specifications, possible user options, etc., there are an enormous number of combinations of vehicle specifications, even for vehicles of the same model. If vehicle display apparatuses should be prepared according to such enormous number of combinations of vehicle specifications, the number of vehicle display apparatuses to be prepared is also enormous.

Further, as the number of types of vehicle display apparatuses increases, the number of types of components required to constitute the vehicle display apparatuses according to the vehicle specifications also increases. This increases the costs of managing the components used for constituting the vehicle display apparatuses, the costs of managing an enormous number of vehicle display apparatuses, etc.

Apart from the need to design different display apparatuses according to differences in the vehicle specifications, there is a concern that the existence of many types of display apparatuses may cause assembly errors in the vehicle manufacturing process. Further, as mentioned above, even for vehicles of the same model, there are many different combinations of vehicle specifications. Hence, it is necessary to add an inspection process to check that a display apparatus according to the vehicle specifications is installed, or that a display apparatus functions properly according to the vehicle specifications. Further, also dealers need to manage a large number of display apparatus. This increases the amount of work required for management.

The vehicle display apparatus disclosed in the above-mentioned publication includes parts usable for all vehicle models in common. However, it just changes the mode of display, selecting from prepared combinations of display specifications. It cannot deal with all differences in the vehicle specifications, and hence does not give an essential solution to the problem that an enormous number of display apparatuses need to be prepared according to differences in the vehicle specifications.

### SUMMARY OF THE INVENTION

This invention has been made in view of the above problems. An object of the invention is to provide a vehicle display apparatus usable for vehicles different in vehicle specifications, in common.

In order to achieve the above problem, a vehicle display apparatus according to this invention comprises a vehicle states detecting means for detecting states of a vehicle, a display means for displaying vehicle information according to the states of the vehicle detected by the vehicle states detecting means, and a mode-of-display changing means capable of changing the mode of displaying the vehicle information on the display means, wherein the mode-of-display changing means receives specifications information about the vehicle and changes the mode of display on the display means according to the specifications information received.

In this case, it is possible to receive specifications information about a vehicle, change the mode of display on the display means according to the specifications information received, and display information about the vehicle according to the states of the vehicle detected.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a diagram showing a schematic structure of a vehicle control system to which a vehicle display apparatus according to an embodiment of this invention is applied;

FIG. 2 is a diagram showing a specific example of a display means shown in FIG. 1, which is an example of an instrument panel installed in a vehicle;

FIG. 3 is a diagram showing an example of a display section in the instrument panel shown in FIG. 2; and

FIG. 4 is a diagram showing another example of the display section which replaces the one shown in FIG. 3.

### DETAILED DESCRIPTION OF THE PREFERRED EMBODIMENTS

A vehicle display apparatus according to an embodiment of this invention will be hereinafter described on the basis of the accompanying drawings.

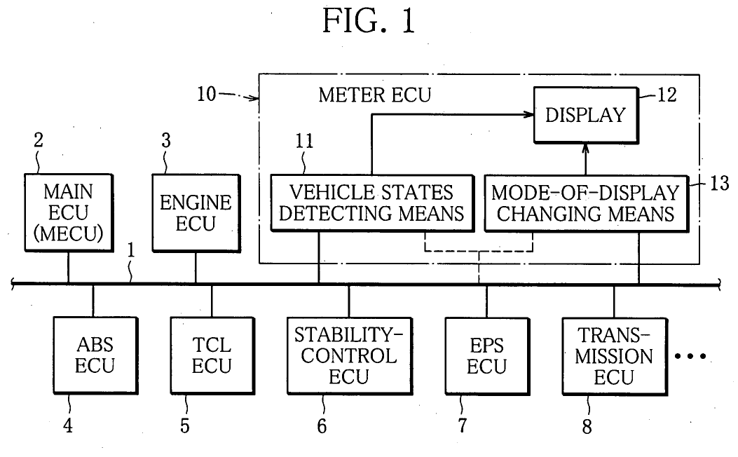

FIG. 1 is a block diagram showing an example of a vehicle control system to which a vehicle display apparatus according to this invention is applied. In this figure, reference numeral 1 denotes a communication bus to which a plurality of control units are connected. The control units connected to the communication bus 1 include a main electronic control unit (MECU) 2 for performing overall control on a vehicle, an engine ECU 3 for performing engine control, an ABS-ECU 4 for performing ABS control, a TCL-ECU 5 for performing TCL control, a stability-control ECU 6 for performing stability control, an EPS-ECU 7 for performing control on electric power steering (EPS), a transmission ECU 8 for performing transmission control, a meter ECU 10 for performing control on meters, etc. Apart from those mentioned, control units can be provided according to the specifications of a vehicle.

Among these control units, the MECU 2 stores vehicle specifications information which was written using a terminal (not shown) in advance of shipment from a factory. This vehicle specifications information includes specifications information relevant to the vehicle display apparatus, such as the vehicle shape, the model year, the specifications of a steering wheel (whether it is for left-hand drive or for right-hand drive), the destination for which the vehicle is intended, the specifications of an engine, the specifications of a transmission, and the specifications of lighting, which will be described later in detail. The specifications information is sent out from the MECU 2 to the communication bus 1, for example when an ignition switch is turned on.

The meter ECU 10 includes a vehicle states detecting means 11 for detecting information about states of the vehicle flowing in the communication bus 11, a display means 12 for displaying vehicle information according to the states of the vehicle detected by the vehicle states detecting means 11, a mode-of-display changing means 13 for changing the mode of display on the display means 12 on the basis of the vehicle specifications information flowing in the communication bus 1.

Roughly speaking, a distinctive feature of the vehicle display apparatus according to the present invention arranged as described above is that the mode-of-display changing means 13 receives the vehicle specifications information sent out to the communication bus 1 by the MECU 2, and changes the mode of display on the display means 12 on the basis of the vehicle specifications information received.

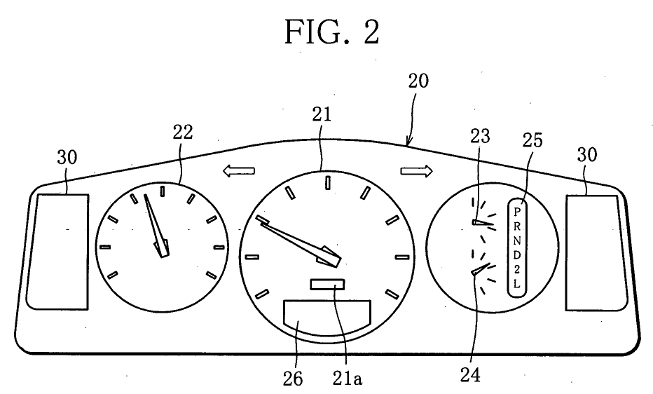

The vehicle display apparatus according to the present invention having this distinctive feature will be described more in detail on the basis of the drawings. FIG. 2 shows an example of an instrument panel 20 of a vehicle display apparatus according to an embodiment of the invention. On the instrument panel 20 are provided, for example a speedmeter 21 for indicating the vehicle speed, a tachometer 22 for indicating the engine speed, a coolant temperature gauge 23 for indicating the engine coolant temperature, a fuel gauge for indicating the amount of fuel remaining, a position light 25 for indicating the gear position of an automatic transmission, an odometer/trip meter 26 indicating the distance traveled, a display section 30 for indicating operating states of devices such as lights and an ABS and displaying warnings according to abnormal states of the vehicle, etc.

As mentioned above, it is arranged that the vehicle specifications information stored in the MECU 2 is sent out to the communication bus 1, for example when the ignition switch is turned on. The meter ECU 10 which receives the vehicle specifications information sets the mode of display on the display means 12 according to the vehicle specifications received. For example, the speedmeter 21 should indicate the speed in the unit of km/h or MPH depending on the destination for which the vehicle is intended. Receiving an instruction to change the mode of display from the mode-of-display changing means 13, the display means 12 sets the speedmeter 21 to display one of the units km/h and MPH prepared for the speedmeter 21 in its unit-of-speed display section 21a, and displays the vehicle speed detected by a vehicle speed sensor (not shown) and converted according to the unit selected. The display means 12 also sets the display section 30 for displaying warnings according to abnormal states of the vehicle as described later, to display warnings in a language suited for the destination.

The display means 12 can change not only the mode of display on the speedmeter 21 but also the mode of display on the tachometer 22. Specifically, receiving the specifications information about an engine installed in the vehicle, which is included in the vehicle specifications information sent out to the communication bus 1 by the MECU 2 as mentioned above, the display means 12 sets the range of indication and, for example the range of a red zone for the tachometer 22 to be suited for the engine.

Further, the odometer/trip meter 26 needs to display the distance traveled in the unit of km or mile depending on the destination for which the vehicle is intended. Thus, the display means 12 identifies the destination from the vehicle specifications information sent out to the communication bus 1 by the MECU 2 as mentioned above, and displays the unit suited for the destination.

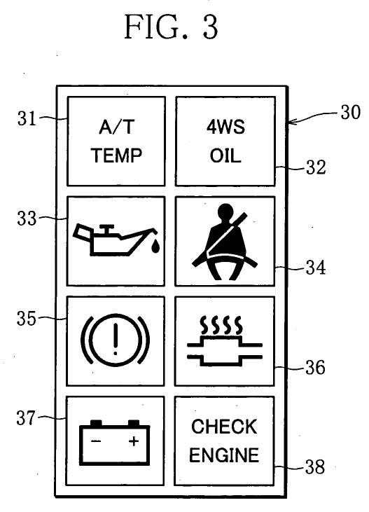

The display section 30 comprises, for example several warning lights as shown in FIG. 3. Specifically, the display section 30 shown in this figure comprises an A/T TEMP light 31 for warning about a rise in the automatic transmission oil temperature, a 4WS OIL light 32 for warning about a decrease in the amount of oil in the 4WS drive mechanism, an oil quantity warning light 33 for warning about a decrease in the amount of engine oil, a seat belt warning light 34 for warning that there is a person not wearing a seat belt, a parking brake indication light 35 for indicating that the parking brake is on, a muffler overheat warning light 36 for warning that the muffler is overheated, a battery warning light 37 for warning that the battery is out of order, and an engine ECU warning light 38 for warning that the engine ECU is out of order.

It is so arranged that receiving warning information sent out by any of the ECU's via the communication bus 1, the vehicle states detecting means 11 turns on a corresponding warning light, namely a corresponding division of the display section 30. However, the devices installed vary according to the vehicle specifications. Specifically, there are vehicles provided with a manual transmission in place of an automatic transmission, and vehicles not provided with 4WS. In such cases, the display section 30 does not need to include the AT/TEMP light 31 or the 4WS OIL light. Hence, the mode-of-display changing means 13 controls the display means 12 not to perform unnecessary display about the devices not installed in the vehicle. Specifically, when the vehicle is provided with a manual transmission in place of an automatic transmission, or not provided with 4WS, the mode-of-display changing means 13 of the meter ECU 10 arranges that the A/T TEMP light 31 or the 4WS OIL light 32 is not turned on, in the display section 30 shown in FIG. 3. After arranged like this, the warning lights are controlled to turn on according to the states of the vehicle detected by the vehicle states detecting means 11 of the meter ECU 10.

As an alternative arrangement, the whole display section 30 can be provided, for example as a liquid crystal display (LCD; not shown), where, receiving the vehicle specifications information in the manner described above, the mode-of-display changing means 13 changes the mode of display on the LCD according to the vehicle specifications information, or in other words, according to the devices installed in the vehicle. This arrangement is preferable because, in this arrangement, the mode of display on the display means 12 can be changed not only to be suited for the vehicle specifications but also to increase the ease of observation, for example. This means an increase in the freedom of displaying information on the display means 12.

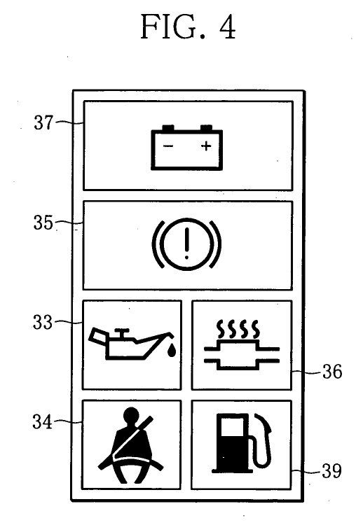

For example, when the vehicle is provided with a manual transmission in place of an automatic transmission and not provided with 4WS nor an engine ECU, the display light 30 is changed to a screen not including the A/T TEMP light 31, the 4WS OIL light 32 nor the engine ECU warning light 38, namely a screen comprising the battery warning light 37, the parking brake indication light 35, the oil quantity warning light 33, the muffler overheat warning light 36, and the seat belt warning light 34 as shown in FIG. 4. In addition to changing the mode of display on the display light 30, or in other words, changing the warning lights displayed on the display means 12 according to the vehicle specifications information received by the mode-of-display changing means 13, it is possible to add, to the display means 12 (display light 30), for example a fuel warning light 39 for warning that only a small amount of fuel remains in a fuel tank (not shown).

Since it is so arranged that the mode-of-display changing means 13 changes the mode of display on the display means 12 according to the vehicle specifications, it is possible to change the display characteristics of the display means 12 according to the vehicle specifications. For example, for a vehicle of the same car model but arranged according to sporty specifications, for example provided with a turbocharger, it is possible to improve the responsiveness of the speedmeter 21 and the tachometer 22. Conversely, for a vehicle provided with a diesel engine, it is possible to lower the responsiveness of the speedmeter 21 and the tachometer 22.

The vehicle specifications information sent out to the communication bus 1 by the MECU 2 also include characteristics of a fuel device (operation instruction parameters, etc. need to be changed according to the capacity and shape of a fuel tank) and vehicle shape information about the vehicle shape. The mode-of-display changing means 13 changes the mode of display on the display means 12 also according to these kinds of specifications information. For example, by setting an instruction parameter, the fuel gauge 24 is given a characteristic that the indicated value is proportional to the amount of fuel remaining in the fuel tank. In addition to this, when the shape of the fuel tank varies according to the vehicle specifications, it is possible to impart display characteristics to the fuel gauge, considering the shape of the fuel tank. Further, although not shown in the drawings, when the positions of the doors vary according to the vehicle specifications, for example depending on whether the vehicle is a one box type or a two box type, it is possible to display a part including the doors on the display means 12 according to the vehicle shape, since the mode-of-display changing means 13 changes the mode of display on the display means 12 according to the vehicle specifications sent out to the communication bus 1 by the MECU 2.

Further, even the vehicles of the same car model can differ depending on the year model, for example due to revisions to regulations or changes (minor changes) to the specifications. In such cases, the mode of display on the display means 12 can be changed according to such revisions to regulations or changes to the specifications, since the mode-of-display changing means 13 changes the mode of display on the display means 12 according to the vehicle specifications.

Although not shown, for example the whole display means 12 can be provided as an liquid crystal display (LCD). Specifically, receiving the vehicle specifications sent out to the communication bus 1 by the MECU 2, the mode-of-display changing means 13 displays a speedmeter, a tachometer, a coolant temperature gauge, a fuel gauge 24, a transmission position light, an odometer/trip meter, warning lights, etc. on the LCD. More specifically, it is so arranged that the mode-of-display changing means 13 detects the vehicle specifications sent out to the communication bus 1 by the MECU 2 and states of devices installed in the vehicle, and displays the states of the devices on the display means 12, namely the LCD.

Even when the vehicle specifications are changed or some changes are made by a user choosing options, it is possible to change the mode of display on the display means 12 according to the vehicle specifications changed, provided that the vehicle specifications changed are stored in the MECU 12. Thus, even when there are an enormous number of combinations of vehicle specifications, the vehicle display apparatus is usable for those combinations in common, and hence the costs and the amount of work required for managing the components used for vehicle display apparatuses and managing an enormous number of vehicle display apparatuses can be reduced. Further, in the case of the vehicle display apparatus according to the present invention, it is not necessary to design different display apparatuses according to differences in the vehicle specifications. This obviates the concern that assembly errors may occur in the vehicle manufacturing process.

As described above, the vehicle display apparatus according to the present invention comprises a vehicle states detecting means 11 for detecting states of a vehicle, a display means 12 for displaying vehicle information according to the states of the vehicle detected by the vehicle states detecting means 11, and a mode-of-display changing means 13 capable of changing the mode of displaying the vehicle information on the display means 12, wherein the mode-of-display changing means 13 receives specifications information about the vehicle and changes the mode of display on the display means 12 according to the specifications information received. Thus, for example, receiving the vehicle specifications information sent out to the communication bus 1 by the MECU 2, the mode-of-display changing means 13 can change the mode of display on the display means 12 according to the vehicle specifications information received.

The apparatus can be so arranged that the display means 12 includes a numerical quantity display section (for example, a speedmeter 21, a tachometer 22, a coolant temperature gauge 23, a fuel gauge 24, etc.) for displaying the vehicle information in the form of numerical quantities according to the states of the vehicle detected by the vehicle states detecting means 11, and that the mode-of-display changing means 13 changes the range of numerical quantities displayed in the numerical quantity display section according to the specifications information. Since it is arranged that the range of numerical values displayed in the display section is changed according to the vehicle specifications, the vehicle display apparatus according to the present invention can display, for example vehicle speed, the amount of fuel remaining, engine coolant temperature, etc. in the display section according to the states of the vehicle detected by the vehicle states detecting means.

Further, the apparatus can be so arranged that the display means 12 includes a display section 30 for displaying the vehicle information in the form of warnings according to the states of the vehicle detected by the vehicle states detecting means 11, and that the mode-of-display changing means 13 changes the mode of displaying warnings in the warning section according to the specifications information. In this case, the vehicle display apparatus according to the present invention can set the mode of display in the display section 30 according to the vehicle specifications and display information in the display section 30 according to the states of the vehicle.

Further, the apparatus can be so arranged that the mode-of-display changing means 13 changes the language used for display on the display means 12 according to the specifications information. In this case, for example, it is possible to change the display of the speed to be in the unit km/h or in the unit MPH, depending on the destination for which the vehicle is intended, and change the language used for display of warnings in the display section 30, depending on the destination.

Further, the apparatus can be so arranged that the vehicle states detecting means 11 detects states of a device installed in the vehicle, that the display means 12 includes a device states display section for displaying the states of the device installed in the vehicle, and that the mode-of-display changing means 13 changes the mode of display in the device states display section according to the specifications information. In this case, for example, it is possible to detect and display states of devices such as an engine, a transmission, a light, a TCL, etc., which devices vary according to the vehicle specifications. Further, the mode-of-display changing means 13 can change the mode of displaying the information about these devices, according to the specifications information about these devices. These are the effects of great practical value.

Specifically, the mode of display on the display means 12 can be changed according to the specifications of the engine by providing display sections for functions, mechanisms or the like of the engine, considering the specifications of the engine. For example, when the engine has cylinder stopping function, a display section for indicating that cylinders are stopped is provided. When the engine has supercharging function, a display section for indicating that supercharging is going on is provided. When the engine has variable valve function, a display section for indicating how the variable valve mechanism is operating.

The mode of display on the display means 12 can be changed according to the specifications of the transmission by providing display sections for functions, mechanisms or the like of the transmission, considering the specifications of the transmission. For example, when the transmission is an automatic transmission, a display section for indicating the automatic transmission control mode is provided.

Likewise, the mode of display on the display means 12 can be changed according to the specifications of another device installed in the vehicle, such as a power transmission (a differential, a transfer, etc.), an ABS, a light or a TCL) by providing display sections for functions, mechanisms or the like of the device, considering the specifications of the device.

In the above, one embodiment of the present invention was described. It is to be noted that the present invention is not limited to this embodiment. For example, in the above embodiment, the vehicle specifications information is stored in the MECU 2 in advance and sent out to the communication bus 1 by the MECU 2, and the mode-of-display changing means 13 changes the mode of display on the display means 12 on the basis of the vehicle specifications information flowing in the communication bus 1. However, it can be so arranged that the meter ECU 10 includes a vehicle specifications identifying means for identifying the vehicle specifications, and that the mode of display on the display means 12 is changed on the basis of the vehicle specifications identified by the vehicle specifications identifying means.

In this case, it can be so arranged that the vehicle specifications identifying means receives the states of the vehicle detected by the vehicle states detecting means 11 and information sent out to the communication bus 1 by the control units such as the engine ECU 3, the ABS-ECU 4 and the TCL-ECU 5, and identifies the specifications of the vehicle. Here, it can be so arranged that the vehicle specifications identifying means 11 identifies the vehicle specifications when the ignition switch is turned on as in the above-described embodiment, and that the mode-of-display changing means 13 sets (changes) the mode of display on the display means 12 according to the vehicle specifications identified.

Compared with the embodiment in which the mode of display on the display means 12 is changed according to the vehicle specifications written and stored in advance, the arrangement in which the vehicle specifications identifying means identifies the vehicle specifications has a merit that the mode of display on the display means 12 can be changed on the basis of the latest vehicle specifications information. For example, even when a device provided as an option is added, replaced or removed, the mode of display on the display means 12 can be set according to the actual vehicle specifications. Thus, information is displayed in the display section 30 without making a driver feel strange.

In the above-described embodiment, the vehicle states detecting means 11 and the mode-of-display changing means 13 of the meter ECU 10 are individually connected to the communication bus 1 to detect information. However, it can be so arranged that the meter ECU 10 is connected to the communication bus 1 by a single line as indicated by a dashed line in FIG. 1 so that the vehicle states detecting means 11 and the mode-of-display changing means 13 detect information via this single communication line.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A vehicle display apparatus comprising:
a vehicle states detecting means for detecting states of a vehicle,
a display means for displaying vehicle information according to the states of the vehicle detected by the vehicle states detecting means, and
a mode-of-display changing means capable of changing the mode of displaying the vehicle information on the display means, wherein
the mode-of-display changing means receives specifications information about the vehicle and change the mode of display on the display means according to the specifications information.

2. The vehicle display apparatus according to claim 1, wherein
the display means includes a numerical quantity display section for displaying the vehicle information in the form of numerical quantities according to the states of the vehicle detected by the vehicle states detecting means, and
the mode-of-display changing means changes at least either the range of numerical quantities displayed in the numerical quantity display section or the display-responsiveness of the numerical quantity display section according to the specifications information.

3. The vehicle display apparatus according to claim 1, wherein
the display means includes a warning display section for displaying the vehicle information in the form of warnings according to the states of the vehicle detected by the vehicle states detecting means, and
the mode-of-display changing means changes the mode of displaying warnings in the warning display section according to the specifications information.

4. The vehicle display apparatus according to claim 1, wherein
the mode-of-display changing means changes the language used for display on the display means according to the specifications information.

5. The vehicle display apparatus according to claim 1, wherein
the vehicle states detecting means detects states of a device installed in the vehicle,
the display means includes a device states display section for displaying the states of the device installed in the vehicle, and
the mode-of-display changing means changes the mode of display in the device states display section according to the specifications information.
